(19) United States
(12) Patent Application Publication
(10) Pub. No.: US 2019/0156386 A1
(43) Pub. Date: May 23, 2019

(54) System and Method for a Location Aware Mobile Application Platform

(71) Applicants: Donovan Moxey, Nassau (BS); Philip Simon, Nassau (BS)

(72) Inventors: Donovan Moxey, Nassau (BS); Philip Simon, Nassau (BS)

(21) Appl. No.: 15/818,213

(22) Filed: Nov. 20, 2017

(51) Int. Cl. G06Q 30/06; G06F 9/445; G06Q 50/26; G06Q 30/02; G06Q 20/38

(52) U.S. Cl. CPC G06Q 30/0601; G06F 8/61; G06Q 50/265; H04W 4/02; G06Q 20/385; G06Q 30/0267; G06Q 30/0277; G06Q 30/0207

(57) ABSTRACT

This document presents a system and method for a location-aware, cloud services mobile platform application that hosts multiple mobile applications via a proprietary mobile application configuration that simultaneously supports multiple functions and End User interactions. The platform application hosts individual and discrete mobile applications specific to each organization or entity, and may engage the End User with one or more Commercial Customers that have a presence within the platform application. The system also provides Functional Channels to the End User to permit interaction with the Commercial Customer via information transfer, as well as mobile commerce transactions. The platform architecture is design with flexibility to allow for the integration of multiple inherent Functional Channels, or custom Functional Channels that integrate with third-party systems via a web services API.

### CLAIM TO PRIORITY

This Non-Provisional Application claims under 35 U.S.C. § 120, the benefit of the Provisional Application 62/425,197, filed Nov. 22, 2016, Titled “System and Method for a Location Aware Mobile Application Platform,” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Mobile application platforms provide services to clients while in communication with the platform. Numerous platforms provide network connection with mobile devices, but are distinguished from one another by the method of communication with the mobile platform and the services available to a user through the platform. Typical services may be initiated and used through one or more messaging interfaces or programming interfaces, such as an application programming interface (API). The services offered to mobile users are typically static in terms of what applications are offered and how the service operates, with updates to the service offerings being pushed out on either an ad hoc, or scheduled basis, with updates and improvements added through the central office update process.

Such mobile application platforms are necessarily limited in the scope of provided services due to the static nature of the offerings, and the difficulty of pushing new functions and features out from a central location. Additionally, the architecture of such mobile application platforms may be static as well, either not planning for, or not permitting, improvements or changes for functions that are different from those planned for in the initial design of the architecture. Because of a lack of functional dynamism, mobile application platforms may be limited in scope and functionality based upon an original lack of planning or implementation of the underlying architecture for the platform.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a high-level system diagram consistent with certain embodiments of the present invention.

FIG. 2 is a view of a detailed diagram for the platform application consistent with certain embodiments of the present invention.

FIG. 3 is a view of the initial KYC input display consistent with certain embodiments of the present invention.

FIG. 4 is a view of the KYC Government Identifier information entry consistent with certain embodiments of the present invention.

FIG. 5 is a view of the completed KYC form to be submitted consistent with certain embodiments of the present invention.

FIG. 6 is a view of the initial TURC display consistent with certain embodiments of the present invention.

FIG. 7 is a view of the End User to be verified consistent with certain embodiments of the present invention.

FIG. 8 is a view of the End User Government Identifier consistent with certain embodiments of the present invention.

FIG. 9 is a view of the TURC approval screen display consistent with certain embodiments of the present invention.

FIG. 10 is a view of End User status change display consistent with certain embodiments of the present invention.

FIG. 11A is a view of the platform application user interface design and functionality consistent with certain embodiments of the present invention.

FIG. 11B is an alternate view of the platform application user interface design and functionality consistent with certain embodiments of the present invention.

FIG. 12 is a view of the platform application user interface main menu display consistent with certain embodiments of the present invention.

FIG. 13 is a view of an End User My Profile display consistent with certain embodiments of the present invention.

FIG. 14 is a view of the End User current GPS location display consistent with certain embodiments of the present invention.

FIG. 15 is a view of the My Coupons display screen consistent with certain embodiments of the present invention.

FIG. 16 is a view of the Commercial Customer display consistent with certain embodiments of the present invention.

FIG. 17 is a view of one or more coupons selected by an End User consistent with certain embodiments of the present invention.

FIG. 18 is a view of the My Wallet function display consistent with certain embodiments of the present invention.

FIG. 19 is a view of End User credit and/or debit card information consistent with certain embodiments of the present invention.

FIG. 20 is a view of the End User credit or debit card to be used consistent with certain embodiments of the present invention.

FIG. 21 is a view of the My Credits Transfer main display consistent with certain embodiments of the present invention.

FIG. 22 is a view of verification of entered information for the My Credits Transfer function consistent with certain embodiments of the present invention.

FIG. 23 is a view of the transfer verification screen for the My Credits Transfer function consistent with certain embodiments of the present invention.

FIG. 24 is a view of a Commercial Customer listing consistent with certain embodiments of the present invention.

FIG. 25 is a view of an AppPage created for Commercial Customers consistent with certain embodiments of the present invention.

FIG. 26 is a view of the Bill Payment main function screen consistent with certain embodiments of the present invention.

FIG. 27 is a view of the Bill Payment transaction display consistent with certain embodiments of the present invention.

FIG. 28 is a view of a transaction confirmation display for the Bill Payment function consistent with certain embodiments of the present invention.

FIG. 29 is a view of a redemption of Credits for cash function consistent with certain embodiments of the present invention.

FIG. 30 is a view of the OTP display to complete a transaction consistent with certain embodiments of the present invention.

FIG. 31 is a view of the user interface configured for a “White Labeled Application,” and consistent with certain embodiments of the present invention.

FIG. 32 is a view of the platform application user interface main menu display configured for a “White Label Application,” and consistent with certain embodiments of the present invention.

FIG. 33 is a view of an AppPage created for Commercial Customers and configured for “White Label Application,” and consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Reference throughout this document to “one embodiment,” “certain embodiments,” “an embodiment,” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

In an embodiment, this document presents a location-aware, cloud services, mobile application platform that can host multiple mobile applications via a proprietary mobile application configuration called an AppPage that can simultaneously support multiple functions and End User interactions. The platform hosts individual and discrete mobile applications, or as defined in the platform, a mobile AppPage that is specific to each organization or entity, and is used to engage the End User with the Commercial Customer that has a presence within the application. The AppPage is designed to provide Functional Channels to the End User that allows them to interact with the Commercial Customer via information transfer, and mobile commerce transactions. The platform architecture is designed with flexibility to allow for the integration of multiple Functional Channels that are inherent to the Application Platform, or custom Functional Channels that integrate with third-party systems via a Web Services API.

The application platform also includes an integrated proprietary Mobile Wallet, and supports mobile commerce with respect to the purchase of products and services, bill payments, donations, and money transfer services between End User accounts within the application's eco-system. To support the money transfer services, the platform includes a proprietary Know Your Customer (KYC) function that allows an End User's identity to be verified and stored within the Platform, and used to facilitate Credits Transfer and cash redemption in exchange for Credits services transactions.

The application platform is developed for the iOS and Android mobile device operating systems.

The application platform architecture is designed and implemented as an Entity-Attribute architecture model, where there are distinct Entities that make up the platform, and each of these Entities have specific Attributes that are unique to each entity, but also allow for interaction between other Entities within the application platform to allow for the exchange of information or the execution of a transaction.

Entity Identification
There are four (4) distinct Entities that make up the platform application. The names and overall description of the role/profile of each of these Entities are outlined below:
1. End User (EU): An individual that has downloaded and installed the application platform, and uses the application to communicate and conduct transactions with Commercial Customers that they have subscribed to by selecting them as their “Favorite.” The End User has a profile within the application platform that can be configured and managed in ways to allow them to utilize specific services within the application. The unique identifier for each End User in the application may be their personal mobile telephone number.
2. Commercial Customer (CC): A business, government, or non-profit organization that has a configured AppPage™ that is part of the application platform. The Commercial Customer can configure their AppPage™ to provide as many available Functional Channels as they wish in order to support communications and transactions with End Users, as well as their employees.
3. Commercial Services Partner (CSP): Independent business entities that have been formally engaged to provide platform services to End Users and Commercial Customers. These services include Account/Mobile Wallet TopUp, Credits Redemption for Cash, and Commercial Customer on-boarding within the application platform.
4. Platform Administrator (PA): An individual who has full administrative access to the application platform, and has the ability to manage all user accounts, as well as monitor all transactions within the platform.

In an embodiment, the application platform architecture is implemented as a GPS location-aware cloud services application for mobile devices. The architecture of the application platform is a flexible, extensible design that provides core functionality for End Users and Commercial Customers, integration with third-party databases and applications via a Web Services API, and a browser based administrative platform for Commercial Customers, Commercial Service Partners, and Platform Administrators.

In this embodiment, the application platform domain model is designed as a cloud-services application solution providing services to Commercial Customers and End Users on a global scale supporting multiple languages, multiple currency types, and multiple devices.

Application Platform

The application platform is composed of four (4) key components:
1. Application Core Platform: includes the main database, all user profiles, messaging and communications server, and key functional and configuration engines for the platform including language and currency translation engines.
2. Web Interface: allows designated Entities to access the Core Platform and perform specific functions that are consistent with their respective user profiles and permissions. Additional user profiles and associated permissions can be created from time to time as may be required.
3. Mobile Devices Interface: allows designated mobile devices to access the platform via their respective “localized” application installed on the device. The platform can be configured to support multiple mobile operating systems as may be required based on market demand. This is possible because the master database and Entity profiles reside within the core platform, and all that is needed is to build a local mobile application that is compatible with the operating system of the respective mobile device.
4. 3^{rd} Party Data Access: allows for connectivity to and information exchange with database repositions and systems that are key to the operation of various functional modules. This could include support for financial transactions, information access, and information reporting.

In an embodiment, the application platform architecture is designed to be extensible and highly scalable with respect to the number of Functional Channels and mobile device operating systems that it can support. The design of the core platform includes a flexible and extensible Applications Programmers Interface (API) that allows for the seamless creation of new functionality as and when required based on market demand. The creation of new functionality is readily accomplished because the core platform contains the Attributes of all Entities in a single relational database.

In an embodiment, the Application Core Platform Architecture includes specific-purpose, Functional Channels that interface with the database and the Attributes/profiles of each Entity. In a non-limiting example, the architecture for the application core platform allows any Functional Module to be built within the platform, via a specific API, and is initiated via the mobile application that resides on the End User's mobile device or a web application. These Functional Modules can also interface with 3^{rd} Party Data resources with respect to the exchange of information and initiation or completion of transactions.

In an exemplary embodiment, the master database of the Core Platform is a Distributed Database System (DDS) allowing for a global reach of the application data, as well as localization of information depending on the local Entity's profile and data requirements. Data/information is readily available to all Entities regardless of the geographic location where the application is utilized. The database system is a Homogeneous Distributed Database Management System (HDDMS) leveraging the use of a single operating system and data structure within the Application Core Platform.

In an embodiment in which the application is dynamically operating in real-time, the platform application requires a consistent and persistent data connection between the mobile application installed on the mobile device and the Core Platform, because all service requests and transactions are processed dynamically based on the End User's current location and preferences stored in their profile. If the End User does not have a data connection (LTE, 4G, 3G, Wi-Fi, or any other wired or wireless data connection) the End User will not be able to utilize the platform application.

In an exemplary embodiment, the Entities and the Attributes associated with each Entity that make up the platform application are presented. The Attributes listed for each Entity are required to enable the functional capabilities and permissions assigned to each Entity in the platform, and are as follows:

Entity Identification with Attributes
1. End User (EU)
   a. Status
      i. Active: End User is allowed to use the platform application to access their profile and initiate transactions.
      ii. Inactive: End User is not allowed to use any functions of the platform application until their status has been changed to “Active.”
   b. Full Name: required
   c. Mobile Telephone Number: required (serves as the unique identifier for the End User's account)
   d. Country: required (this is the country where the mobile phone number has been issued for the device)
   e. Email Address: required
   f. Gender (Male or Female): not required (used for demographic and behavioral analytics)
   g. Month of Birth: not required (used for demographic and behavioral analytics)
   h. Year of Birth: not required (used for demographic and behavioral analytics)
   i. Current GPS Location: required
   j. Home Location: not required
   k. Know Your Customer (KYC) Status: not required
      i. Pending: in this state, the End User is not allowed to conduct Credits/Funds Transfer or Credits/Funds Redemption transactions.
      ii. Approved: in this state, the End User is allowed to conduct Credits/Funds Transfer and Credits/Funds Redemption transactions.
   l. Radius of Interest: required (allows the Core Platform to dynamically present content to the End User based on their GPS location and Radius of Interest preference setting)
2. Commercial Customer (CC)
   a. Commercial Name: required
   b. Commercial Number (Tax ID): required (used as a unique identifier)
   c. Commercial Address: required
   d. Country: required
   e. Physical GPS Location: required
   f. Name of Authorized Representative: required
   g. Email Address: required
   h. Phone Number: required
3. Commercial Services Partner (CSP)
   a. Commercial Name: required
   b. Commercial Number (Tax ID): required (used as a unique identifier)
   c. Commercial Address: required
   d. Country: required
   e. Physical GPS Location: required
   f. Name of Authorized Representative: required
   g. Email Address: required
   h. Phone Number: required
4. Platform Administrator (PA)
   a. Full Name: required
   b. Phone Number: required
   c. Email Address: required

In an embodiment, there are three (3) proprietary core functions in the platform application that have been designed and implemented in a novel and innovative manner. These functions are:
I. Know Your Customer (KYC): Management of the End User's KYC Status
II. Credits/Funds Transfer: Transfer of Credits/Funds between End Users, including transfers between End Users in the same country and transfers between End Users in two different countries
III. Credits/Funds Redemption: Redemption of cash in exchange for Credits within the platform

I. Know Your Customer (KYC): Management of the End User's KYC Status

In an exemplary embodiment, the “KYC Status” function is designed to allow an End User to register within the platform application, in addition to registering for the platform application itself, so that each End User can be allowed to transfer Credits and receive cash in exchange for Credits from the platform application accounts as part of the redemption process. The KYC Status function must be set to “Approved” in order for an End User to be allowed to transfer Credits to another End User, or receive cash in exchange for Credits managed and maintained by the platform application. This “KYC Status” function resides under the “My Profile” section of the platform application primary user screen.

In an embodiment, there are four primary actors which interact with the platform application, and are as follows:

Actor Identification
1. End User (EU): An individual who has installed and registered the platform application.
2. TopUp Redemption Partner (TURP): A TopUp Partner that has been authorized to provide cash in exchange for Credits to EU Customers.
3. TopUp Redemption Clerk (TURC): A person who works for a TURP who has access credentials within the platform, and is allowed to process TopUp and Redemption Transactions.
4. Platform Administrator (PA): A platform application employee with administrative access credentials for each feature and function of the platform and the platform application.
In an embodiment, there are four (4) key steps that are associated with the KYC Status Function Workflow:
1. Enrollment in the KYC Status Function by the End User
2. Review and Activation of the End User's KYC Status by the TURC
3. Maintenance of the KYC Status by the Platform Application
4. Reconciliation and Reporting of the KYC Status Within the Platform Application

KYC Status Function Workflow

1. Enrollment in the KYC Status Function by the End User
a. The End User will select the “My Profile” page with the platform application. Their KYC Status will be by default set to “Pending.” In this state, the End User cannot perform the following transactions:
   i. Transfer Credits to another End User
   ii. Redeem Cash for Credits from an authorized TURP
b. The End User will select the “KYC Status” edit option to begin the enrollment process.
c. The End User will complete the following information fields:
   i. Official Government-Issued Document Type (Drop Down Selection—Select Only One):
      1. Passport
      2. Birth Certificate
      3. Driver's License
      4. National ID Card
   ii. Document Issue Date: Month Day Year (MM/DD/YYYY)
   iii. Document Expiration Date: Month Day Year (MM/DD/YYYY)
      1. The End Users KYC Status will automatically expire and be reset to “Pending” when their document expiration date expires.
      2. Upon KYC Status Expiration, the End User will not be able to transfer or receive platform application Credits, or redeem cash in exchange for Credits within the platform application.
   iv. Country of Issue: Dropdown list of all available countries (Select Only One)
   v. Name as it appears in the Document: End User will type in their full name
   vi. Document ID Number: Field can accept alphanumeric characters and symbols
   vii. Document Image Upload (two options):
      1. End User can take a photo of their document within the platform application, and upload it into the system (.jpg or .png file); or
      2. End User can browse their mobile files, select, and upload an image file of their document (.pdf, .jpg, or .png file format).
d. After all of the information has been entered, the End User will select the “Save” Button. The End User will then receive the following message: “Please go to a designated Redemption Partner with your Government-Issued Document to have your KYC Status approved.”
e. After selecting the “Save” button the End User's KYC Status will remain set to “Pending.” The KYC Status will remain set to “Pending” until after the End User's documents have been inspected in person by a TURC.

2. Review and Activation of the End User's KYC Status by the TURC
a. The End User will approach the TURC and provide their phone number.
b. The TURC will enter the phone number and search for the End User's KYC Status application in the platform.
c. The TURC will select the End User's Account, and then select the KYC Status Management option in the platform.
d. The TURC will ask the End User to present the original and authentic version of the Government-Issued Document that was used to registered the KYC Status enrollment.
e. The TURC will inspect the End User's document, and compare it to the information that has been uploaded in the system; all information must match exactly.
   i. Document Type
   ii. Document Issue Date
   iii. Document Expiration Date
   iv. Country of Issue
   v. End User's Name as it appears in the document
   vi. Document ID Number
   vii. Authenticity (Based on the TURC's training regarding how to inspect and authenticate Government-Issued Documents)
f. If the Document is found to be authentic after inspection, and exactly matches the information entered into the system, the TURC will set the KYC Status to “Approved.”
   i. The platform will keep a record of the date, time, and name of the TURC and associated TURP that approved the KYC Status of the End User.
   ii. The End User will be able to perform Credits Transfer and Redemption transactions.
g. The End User's KYC Status will remain as “Approved” until one of the following happens:
   1. The Document expires on the expiration date—The KYC Status will automatically be change to “Pending” by the platform.
      a. The End User will NOT be able to send or receive platform application Credits.
      b. The End User will NOT be able to redeem cash for platform application Credits.
   2. A Platform Administrator changes the KYC Status from “Approved” to “On Hold.”
      a. This change can be done for security reasons either permanently or temporarily.
      b. Only a Platform Administrator can make this type of change to the End User's KYC Status.
      c. The End User will NOT be able to perform Credits Transfer or Redemption transactions when the status is “On Hold.”
   3. The End User makes voluntarily changes to their KYC Status profile and documents.
      a. After the changes have been made the End User's KYC Status will automatically be changed to “Pending” until it is changed to “Approved” by a TURC.
h. If the End User's Document is found to be inauthentic after inspection, or the information on the Document does not exactly match the information entered into the system, the TURC will allow the KYC Status remain as “Pending.”
   1. The End User will be informed that they need to edit their KYC profile and make changes to their Document and/or information so that their KYC Status can be set as “Approved.” They cannot perform Credits Transfer or Redemption transactions; however, they remain able to edit their KYC profile.
   2. After making the requested edits, the End User can present the Document to the TURC for review and approval; this can repeat as needed until the End User's Document is found to be authentic and the information on the Document exactly matches the information entered into the system.

3. Maintenance of the KYC Status by the Platform Application
a. The platform application will maintain the KYC Status for each End User.
b. Each time the End User wants to perform a Credits Transfer or Credits Redemption transaction, the system will check their status and will only allow these transactions to be performed if the End User's KYC Status is set to “Approved.”
c. The platform application will also keep a record of the name and location of the TURC and associated TURP that set the End User's KYC Status to “Approved,” along with the date and time of any changes to the End User's KYC Status.
d. The MobileAssist™ platform will also manage the transfer of Credit/funds between End Users that are registered in different countries via a Master Credits Transfer Grid.

4. Reconciliation and Reporting of the KYC Status within the Platform Application
a. The platform application will keep track of every KYC Status record in the platform. Only the Platform Administrator will have access to the full record of this information.
b. The KYC Status records may be comprised of (but are not limited to) the following:
   i. A list of all End Users with a KYC Status set to “Pending,” including all information and data that has been provided by the End User.
   ii. A list of all End Users with a KYC Status set to “Approved,” including all information and data that has been provided by the End User.
   iii. The identification and location of each TURC and associated TURP that has issued KYC Status approvals in the platform, including the dates and times of each status approval.
c. After an End User's KYC Status has been set to “Approved,” the End User's KYC information will not be visible to a TURC.

II. Credits/Funds Transfer: Transfer of Credits/Funds Between End Users

The Credits Transfer function allows an End User to transfer platform application Credits to another End User who is registered in the same country. In order to successfully execute this function, both the transferring End User's KYC Status and the receiving End User's KYC Status must be set to “Approved” in the app.

In an exemplary embodiment, the platform application may also manage the transfer of Credits/Funds between End Users that are registered in different countries via a Master Credits Transfer Grid. This grid is presented in Table 1:

TABLE 1
Example of a Credits Transfer Grid Between Countries

| | Bahamas | Jamaica | USA | India | Etc . . . |
|---|---|---|---|---|---|
| Bahamas | 1 | 1 | 0 | 0 | 0 |
| Jamaica | 1 | 1 | 0 | 1 | 0 |
| USA | 0 | 0 | 1 | 0 | 0 |
| India | 0 | 1 | 0 | 1 | 0 |
| Etc . . . | 0 | 0 | 0 | 0 | 1 |

As presented above, Credits Transfers are allowed within each country, and between the following countries:

1. Bahamas & Jamaica

2. Jamaica & India

All cross-border/country-to-country transactions will be allowed on a case-by-case basis after the respective regulatory requirements have been satisfied. In an exemplary embodiment, if the Recipient End User's KYC Status is set to “Pending” or “On Hold,” the transaction will NOT be allowed to proceed. The End User will need to have their status set to “Approved” via the methods outlined above in the KYC Status Function Workflow

In an embodiment, the “My Credits Transfer” function is located under the main menu listing in the platform application, and the actors are as follows:

Actor Identification
1. End User (EU): An individual who has installed and registered the platform application.
2. TopUp Redemption Partner (TURP): A TopUp Partner that has been authorized to provide cash in exchange for Credits to EU Customers.
3. TopUp Redemption Clerk (TURC): A person who works for a TURP who has access credentials within the platform, and is allowed to process TopUp and Redemption Transactions.
4. Platform Administrator (PA): A platform application employee with administrative access credentials for each feature and function of the platform and the platform application.

Credits Transfer Function
In an exemplary embodiment, the system has defined four (4) key steps that are with the Credits Transfer Function:
1. Entering the Mobile Number and Country of the Recipient of the Credits Transfer
2. Verification of the Name, Phone Number, and Location of the Recipient of the Credits Transfer and Entering the Amount of the Credits Transfer
3. Submission and Completion of the Credits Transfer Transaction
4. Management, Reconciliation, and Reporting of the Credits Transfer within the Platform Application

Credits Transfer Function Workflow

1. Specifying the Recipient of the Credits Transfer
a. Select the “My Credits Transfer” option under the main menu listing in the platform application.
b. Enter the mobile number and country of the Recipient End User in the form fields provided in the app, and select the “Submit” button.

2. Verification of the Recipient End User
a. The request which includes the phone number and country of the Recipient End User will be sent from the app to the platform application database for verification. If the Recipient End User account is in the platform application database and they are authorized to receive Credits, the platform will display the Recipient End User's registered name, phone number, and country, along with a field where the amount of Credits to be transferred to the Recipient End User's account may be entered.
b. If the Recipient End User account does not exist in the platform application database, an error message will be displayed, and the Sender End User will be allowed to re-enter the Recipient End User's phone number and country of registration.
c. If the Recipient End User account exists in the platform application database but is not authorized to receive Credits, an error message will be displayed, and the Sender End User will not be allowed to proceed with the attempted transfer.

3. Submission and Completion of the Credits Transfer Transaction
a. The Recipient End User's name, phone number, country, and amount of Credits to be transferred will be submitted to the platform.
b. If the transfer is being made from one country to another, the Platform uses the integrated Credits Conversion Engine (CCE) to determine what the amount of Credits transferred will be in the Recipient End User's country of registration. The Credits Conversion Engine (CCE) uses a real-time currency converter to make the transfer calculation. Credits are valued based on global currency exchange rates.
   EXAMPLE: 100 Credits in the Bahamas would become 12,810 Jamaican Credits, and 12,810 Jamaican Credits would become 100 Bahamian Credits, less the applicable transaction fee that is charged to the Recipient End User by the platform.
c. If the transfer is allowed between the two countries in the platform, the transaction will be processed.
d. If the transfer of Credits is not allowed between the two countries, the transaction will not be processed, and an error message will be displayed to the Sender End User.

4. Management, Reconciliation, and Reporting of the Credits Transfer within the Platform Application
a. The platform application will keep track of every Credits Transfer that occurs within the system. Only the Platform Administrator will have access to the full record of this information. The transaction record may include (but is not limited to) the date and time of transfer, the name of the Sender End User and Recipient End User, the amount of Credits transferred, and the fees charged for the transfer transaction.
b. Both the Sender and Recipient End Users will receive an automated email providing a record of the transaction. A record of the transaction will also be displayed under the “My Transactions” menu listing.
c. The Platform Administrator will be able to configure/manage all cross-border/country-to-country transactions allowed, and the maximum amount of Credits that are allowed to be transferred.

III. Credits/Funds Redemption: Redemption of Cash in Exchange for Credits

In an embodiment, the Credits Redemption function allows the Recipient End User to redeem Credits for cash by initiating and confirming the transaction in the platform application. In order to successfully execute this function, both the transferring End User's KYC Status and the receiving End User's KYC Status must be set to “Approved” in the app.

In a non-limiting example, the “Credits Redemption” function is located within the “My Wallet” function under the main menu listing in the platform application, and the actors are as follows:

Actor Identification
1. End User (EU): An individual who has installed and registered the platform application.
2. TopUp Redemption Partner (TURP): A TopUp Partner that has been authorized to provide cash in exchange for Credits to EU Customers.
3. TopUp Redemption Clerk (TURC): A person who works for a TURP who has access credentials within the platform, and is allowed to process TopUp and Redemption Transactions.
4. Platform Administrator (PA): A platform application employee with administrative access credentials for each feature and function of the platform and the platform application.

Credits Redemption Function

In an exemplary embodiment, the system has defined four (4) key steps that are associated with the Credits Redemption Function:
1. Entering the Amount of Credits to be Redeemed for Cash
2. Submission of the Authorization One Time Passcode (aOTP) to the TURC and Initiating the Transaction
3. Confirmation of the Transaction with the Verification One Time Passcode (vOTP) Provided to the TURC, Completion of the Transaction, and Receipt of Cash From the TURC for Credits
4. Management, Reconciliation, and Reporting of the Cash for Credits Redemption Transaction within the Platform Application

Credits Redemption Function Workflow

1. Entering the Amount of Credits to be Redeemed for Cash
a. Select the “My Wallet” function from the menu page in the main data entry display presented by the platform application.
b. The Recipient End User must “open” their wallet with their Personal Identification Number (PIN), if the wallet is not already opened. The wallet is “open” when the End User has selected the wallet and activated the wallet function to perform transactions.
c. Select the “Redemption Request” button.
d. Enter the amount of Credits that the Recipient End User may want to redeem and select the “Submit” button.
e. The platform application may then send the Recipient End User a unique eight (8) digit alphanumeric Authorization One Time Passcode (aOTP) via Short

Message Service (SMS) to their mobile phone number that is stored as part of their profile in the platform application.
i. The eight (8) digit number consists of 4 letters and 4 numbers, providing the possibility of 4,569,760,000 different 8-digit number combinations.
ii. The Recipient End User has a pre-defined amount of time set by the platform to use the aOTP in order to complete the redemption transaction.
f. The Recipient End User may also be sent an email notification of the redemption request that has been made to the email address that is on file in the platform as part of their profile.

2. Providing the Authorization One Time Passcode (aOTP) to the TURC
a. The Recipient End User will present the Redemption aOTP to the TURC in person.
b. The TURC enters the 8-digit code into the platform, and will lock the transaction to the TURC's account, and the system will not allow the aOTP to be reused by another Recipient End User or TURC after the system has been locked.
c. The system may present to the TURC the following information:
   i. Full name of the Recipient End User who has made the redemption request
   ii. The amount of Credits requested to be redeemed
   iii. The fees charged to the Recipient End User for the redemption transaction
d. The TURC will verify the information with the Recipient End User to ensure that the information provided is correct.

3. Confirmation of the Transaction with the Verification One Time Passcode (vOTP) Provided to the TURC, Completion of the Transaction, and Receipt of Cash From the TURC for Credits
a. The Platform will send the Recipient End User the 8-digit Verification One Time Passcode (vOTP) via SMS.
b. The TURC will request this vOTP code from the Recipient End User to complete the transaction.
c. After the correct vOTP code is entered into the platform, the transaction will be approved and the TURC will then provide the Recipient End User with Cash for the redeemed Credits, less any transaction fees that have accrued.

4. Management, Reconciliation, and Reporting of the Credits Redemption within the Platform Application
a. The platform application will keep track of every Credits Redemption transaction that occurs within the platform. Only the Platform Administrator will have access to the full record of this information.
b. The transaction record may include (but is not limited to) the date and time of redemption, the name of the Recipient End User, the amount of Credits redeemed, the fees charged for the transfer transaction, and the name of the TURC and associated TURP.
c. A record of all redemption transactions will remain in an electronic database associated with the platform application. The Recipient End User will receive an automated email providing a record of the transaction. A record of the transaction will also be displayed under the “My Transactions” menu listing.
d. The Platform Administrator will be able to manage/configure the maximum amount of Credits allowed to be redeemed for cash.

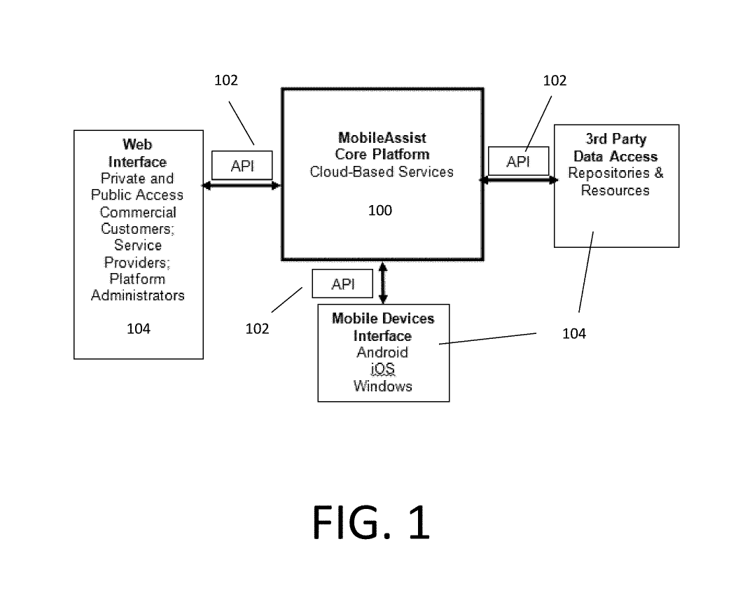

Turning now to FIG. 1, this figure presents a view of a high-level system diagram consistent with certain embodiments of the present invention. In an exemplary embodiment, this presents the domain model for the system with the inter-related functions for Web access, the interface to mobile devices, and the interface and repositories for 3^{rd} party data access to the system. The platform application is built upon cloud-based services 100 and permits interaction among all major components through APIs 102 and messaging to and from the components of the system 104.

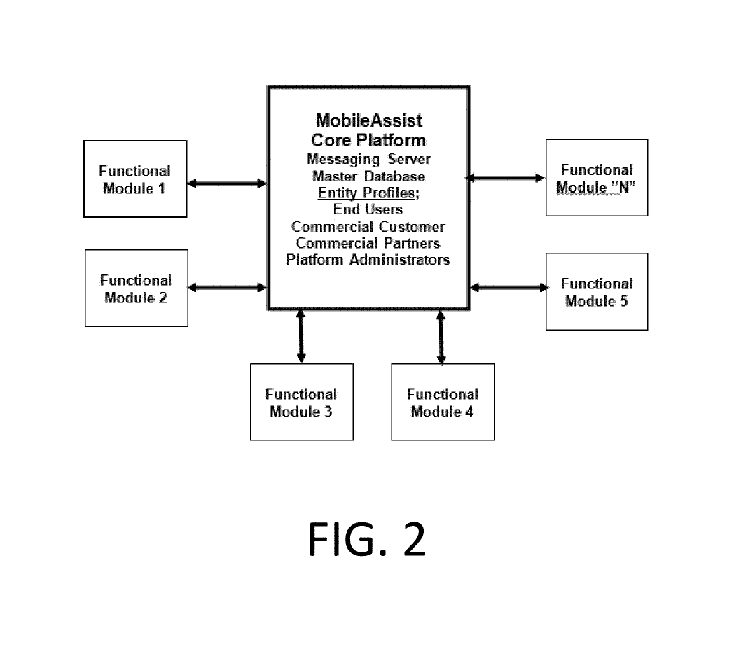

Turning now to FIG. 2, this figure presents a view of a detailed diagram for the platform application consistent with certain embodiments of the present invention. In an exemplary embodiment, the system presents a more detailed view of the platform application and the interaction between the functional modules of the system. The core platform manages the central database containing all End User and Commercial Customer files. In addition, the core platform manages the interaction between Commercial Customers, Commercial Partners, Platform Administrators, and all End Users of the system. In this Figure, functions 1 through 5 represent simultaneous operation of functions supporting interaction with approved users, with function N representing a variable integer value greater than or equal to six, that indicates the upward bound of functions capable of being supported by the application.

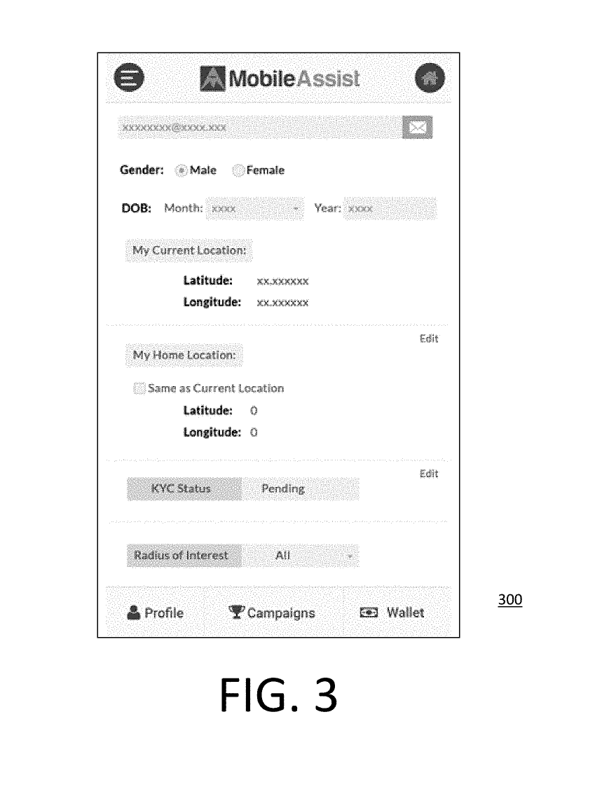

Turning now to FIG. 3, this figure presents a view of the initial KYC input display consistent with certain embodiments of the present invention. In an exemplary embodiment, the End User's KYC Status is initially by default set to “Pending” in the Mobile Assist application at 300.

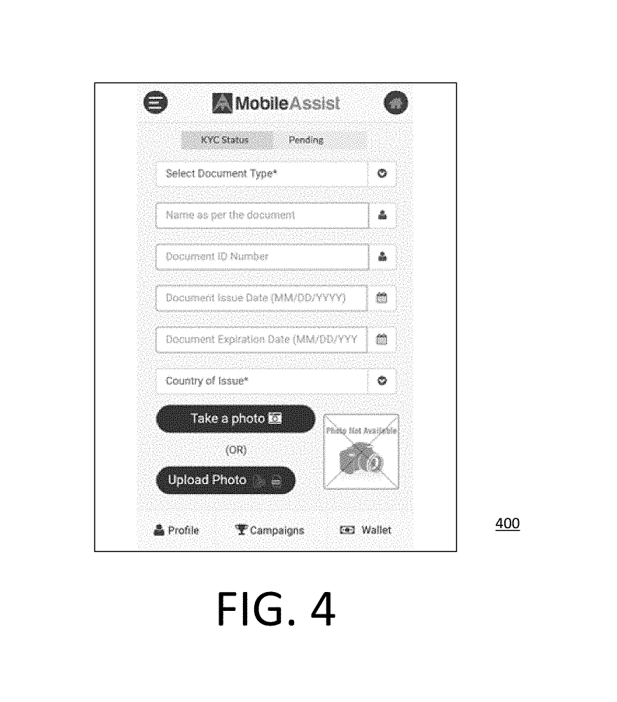

Turning now to FIG. 4, this figure presents a view of the KYC Government Identifier information entry consistent with certain embodiments of the present invention. In an exemplary embodiment, the End User will enter their Government-Issued Document information along with a clear high-resolution image of the Document via the form provided in the platform application. This information will be submitted for review and verification by a designated TURC at 400.

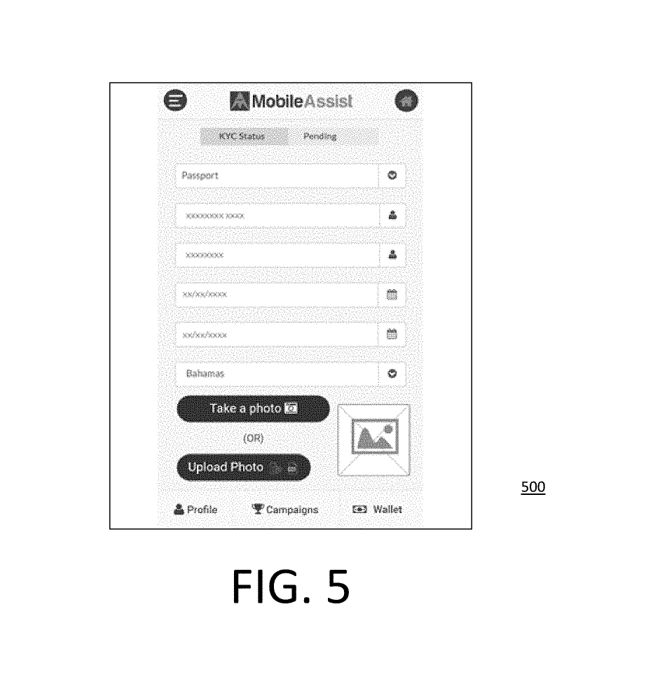

Turning now to FIG. 5, this figure presents a view of the completed KYC form to be submitted consistent with certain embodiments of the present invention. In an exemplary embodiment, the completed KYC form will be submitted via the platform application at 500.

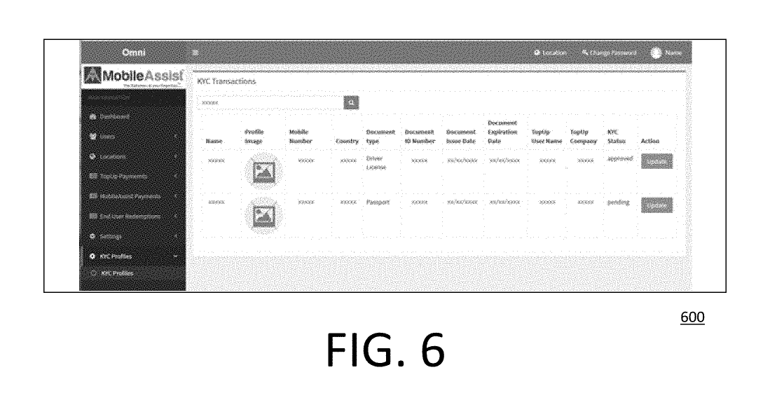

Turning now to FIG. 6, this figure presents a view of the initial TURC display consistent with certain embodiments of the present invention. In an exemplary embodiment, the TURC will search and select the End User's KYC Status submission for review and inspection at 600.

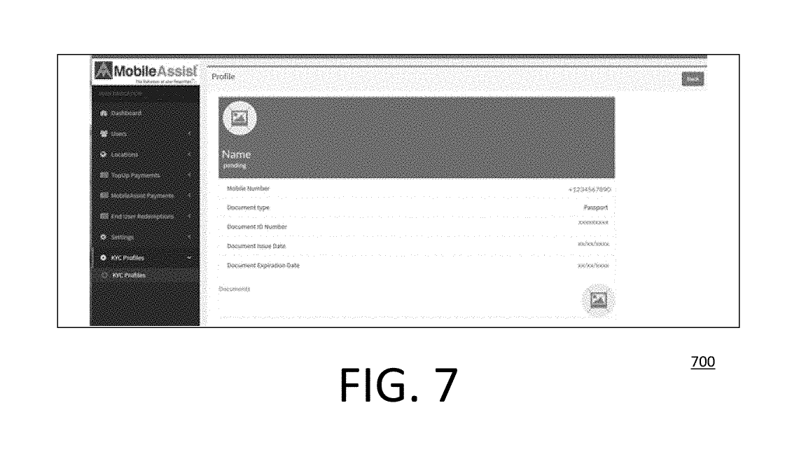

Turning now to FIG. 7, this figure presents a view of the selection of the End User to be verified consistent with certain embodiments of the present invention. In an exemplary embodiment, the TURC reviews the retrieved information about the End User at 700.

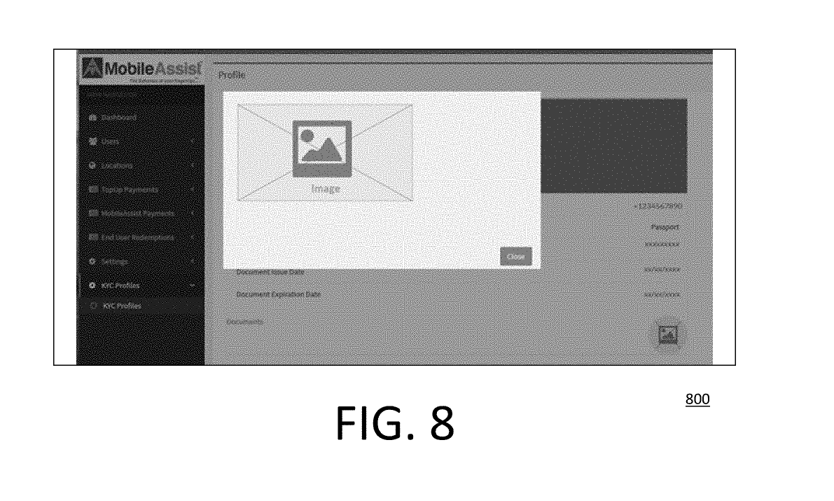

Turning now to FIG. 8, this figure presents a view of the display of the End User Government Identifier consistent with certain embodiments of the present invention. In an exemplary embodiment, the TURC will inspect and authenticate the Government-Issued Document provided by the End User and verify the information submitted via the platform application at 800.

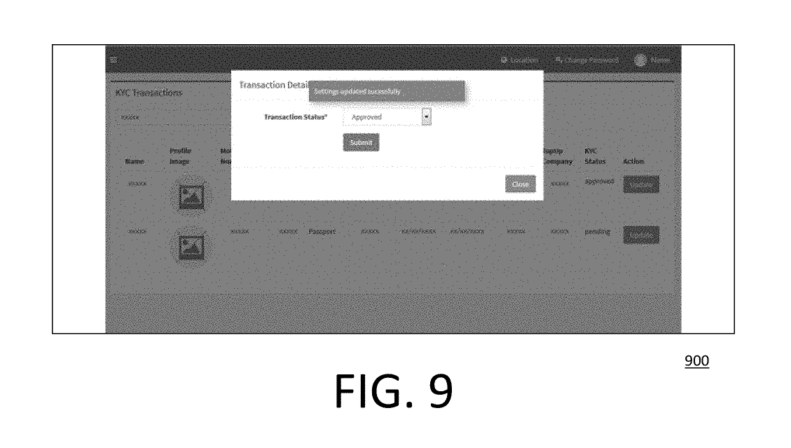

Turning now to FIG. 9, this figure presents a view of the TURC approval screen display consistent with certain embodiments of the present invention. In an exemplary embodiment, after the Government-Issued Document has been found to be authentic and the information provided has been verified to exactly match the information on the Government-Issued Document, the TURC will set the End User's KYC Status to “Approved” at 900.

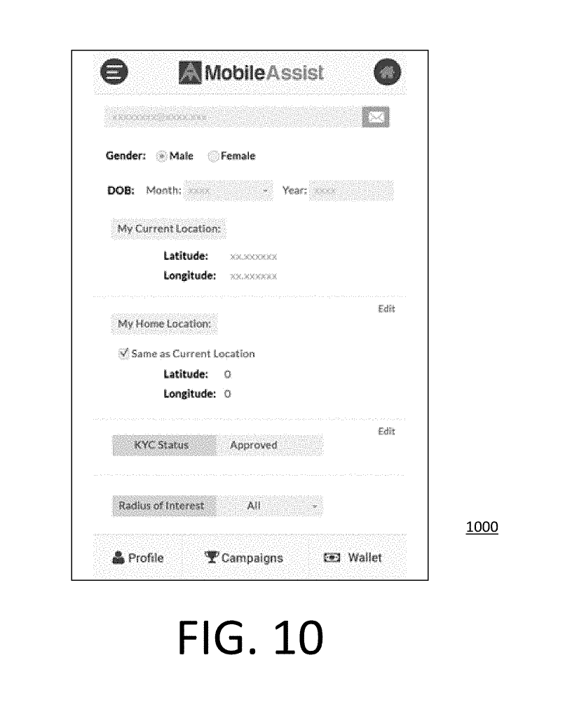

Turning now to FIG. 10, this figure presents a view of the End User status change display consistent with certain embodiments of the present invention. In an exemplary embodiment, the End User's KYC Status will be changed to “Approved” in the platform application, and the End User will now be allowed to perform Credits Transfer and Credits Redemption transactions at 1000.

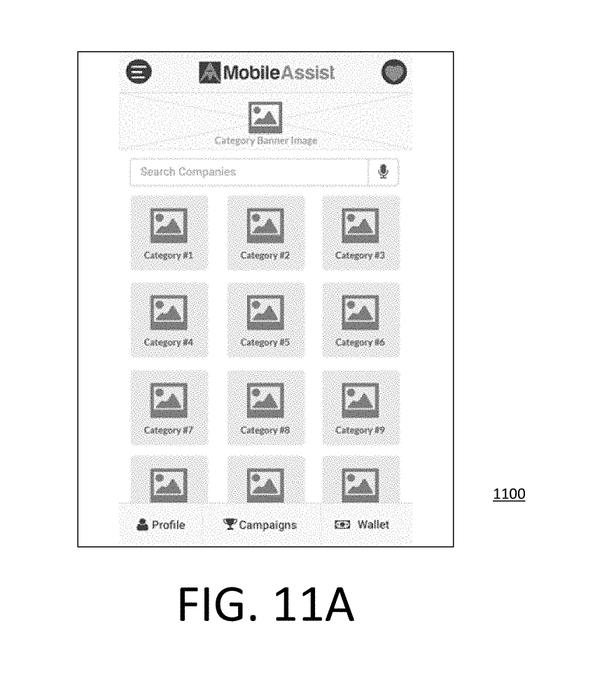

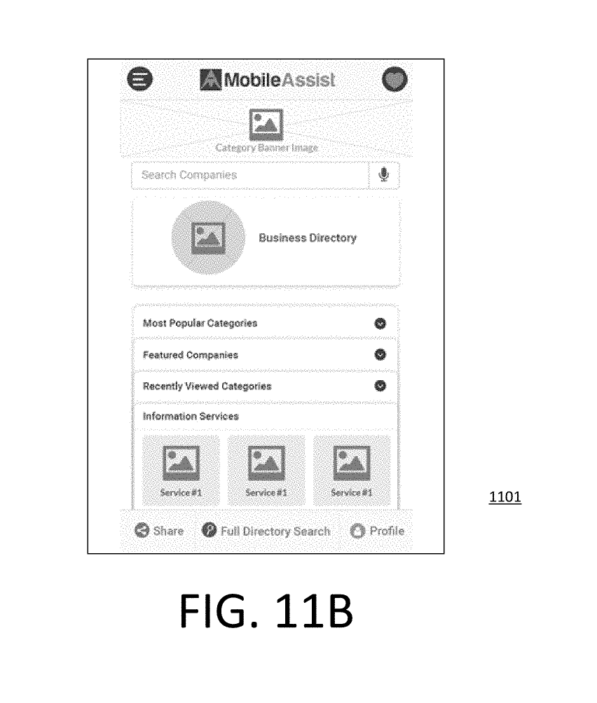

Turning now to FIG. 11A, this figure presents a view of the platform application user interface design and functionality consistent with certain embodiments of the present invention. In an exemplary embodiment, the “Home Page” or “Dashboard” of the platform application consists of a plurality of key design elements. The design elements include but are not limited to a menu icon in the top left icon that is used to present a listing of the app's menu items by sliding the screen to the right, a Home icon on the top right that is used to take the End User to the Home screen as a default setting, a top banner that can be dynamically changed based on the location and stored profile of the End User, a Search field that allows the End User to search the app by Category name, and Category icons (up to 120 in total) that the End User can select to go to a listing of Commercial Customers that are assigned to that category. In a non-limiting example, these banners may be linked to internal functions within the API or to external resources, and the Search Field allows for both text and voice search within the application. Additionally, the Dashboard may display quick access links to the End User's “Profile,” the “My Campaigns” listing, and the End User's ‘Wallet.” The architecture of the platform allows for modification of the functional button area of the application as market demands indicate. In a non-limiting example, the bottom Footer section allows for three functional menu items. Additional functionality may be presented as functions are added to the Dashboard at 1100.

Turning now to FIG. 11B, this figure presents a view of the platform application user interface design and functionality consistent with certain embodiments of the present invention. In an exemplary embodiment, the “Home Page” or “Dashboard” of the platform application consists of a plurality of key design elements. The design elements include but are not limited to a menu icon in the top left icon that is used to present a listing of the app's menu items by sliding the screen to the right, a Home icon on the top right that is used to take the End User to the Home screen as a default setting, a top banner that can be dynamically changed based on the location and stored profile of the End User, a Search field that allows the End User to search the app by Category name, and Category icons (up to 120 in total) that the End User can select to go to a listing of Commercial Customers that are assigned to that category. In a non-limiting example, these banners may be linked to internal functions within the API or to external resources, and the Search Field allows for both text and voice search within the application. Additionally, the Dashboard may display quick access links to the End User's “Profile,” the “My Campaigns” listing, and the End User's ‘Wallet.” The architecture of the platform allows for modification of the functional button area of the application as market demands indicate. In a non-limiting example, the bottom Footer section allows for three functional menu items. Additional functionality may be presented as functions are added to the Dashboard at 1101.

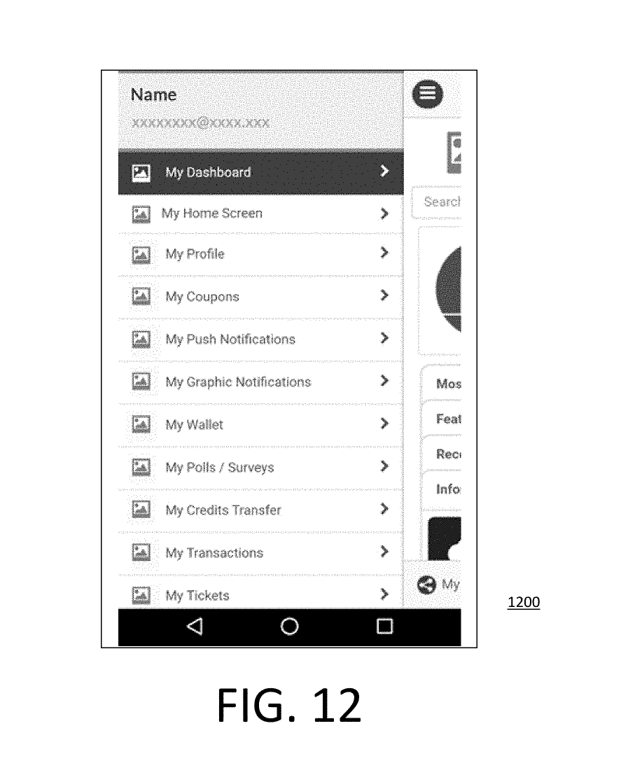

Turning now to FIG. 12, this figure presents a view of the platform application user interface main menu display consistent with certain embodiments of the present invention. In an exemplary embodiment, the Main Menu Listing 1200 in the app is designed to manage all of the high-level functions in the platform application, and includes the following menu items:
1. The name and email address of the End User who has registered to use the app
2. A list of informational and functional items that can be modified as may be required given market and/or functional needs.
3. My Dashboard: access to the home page
4. My Profile: access to the End User's profile
5. My Coupons: access to opt-in coupons
6. My Wallet: access to all wallet functions
7. My Credits Transfer: manage potential Credits transfers to other End Users
8. My Transactions: record of all transactions initiated in the app
9. My Tickets: listing of all purchased tickets
10. My Campaigns: access to all available promotional campaigns
11. My Favorites: access to all opt-in favorites
12. My Push Notifications: access to all text push notifications
13. My Graphic Notifications: access to all graphic notifications
14. Advanced Search: ability to search against all Commercial Customer listings in the app
15. Settings: access to manage all global settings in the app.
16. App Version Number: listing of the currently installed version of the app.

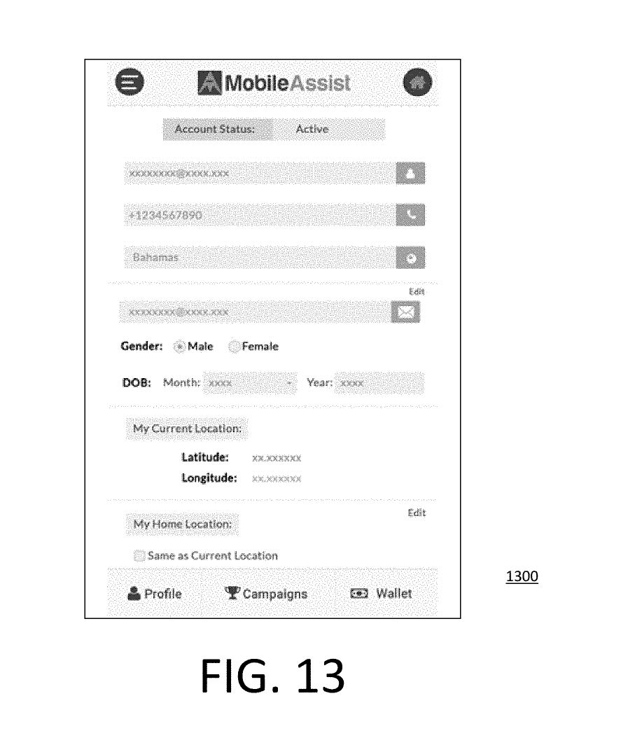

Turning now to FIG. 13, this figure presents a view of an End User My Profile display consistent with certain embodiments of the present invention. In an exemplary embodiment, the My Profile page 1300 may include, but is not limited to, the following informational and functional elements: Account Status (this may display the “Active” or ‘inactive” status of the End User's account; the Platform Administrator controls this setting); the End User's name; phone number; country of registration; email address; gender; and month and year of birth. Additional parameters may be determined to be necessary to display periodically, and the screen display may be updated to reflect the updated informational and functional elements.

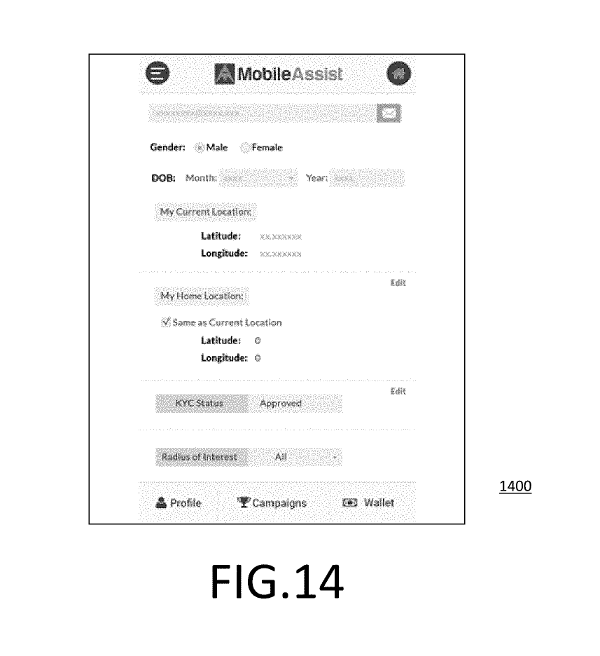

Turning now to FIG. 14, this figure presents a view of the End User current GPS location display consistent with certain embodiments of the present invention. In an exemplary embodiment, this display presents End User's current GPS location and the End User's home GPS location and address 1400. This display also presents the End User's KYC Status in terms of Pending or Approved status, as well as providing the End User the ability to manage the status information. The display may also present the Radius of Interest, including the ability of the End User to modify the Radius of Interest as per their preference. Based on the setting the End User will only see new Commercial Customer listings that are within their Radius of Interest given their current GPS location. The display also presents the End User's “Favorites,” defined as the End User's preferred location settings, which will always be listed and visible.

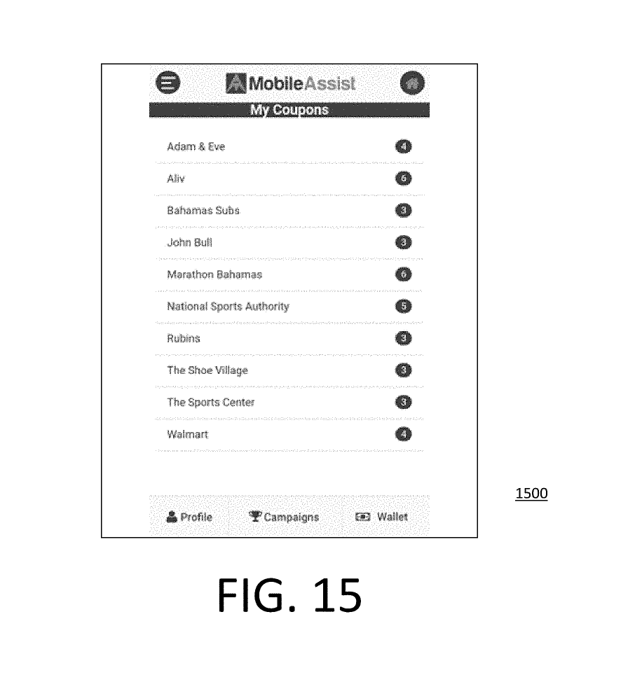

Turning now to FIG. 15, this figure presents a view of the My Coupons display screen consistent with certain embodiments of the present invention. In an exemplary embodiment, the “My Coupons” management function provides an alphabetical listing by all Commercial Customers of all coupons that have been saved by the End User at 1500.

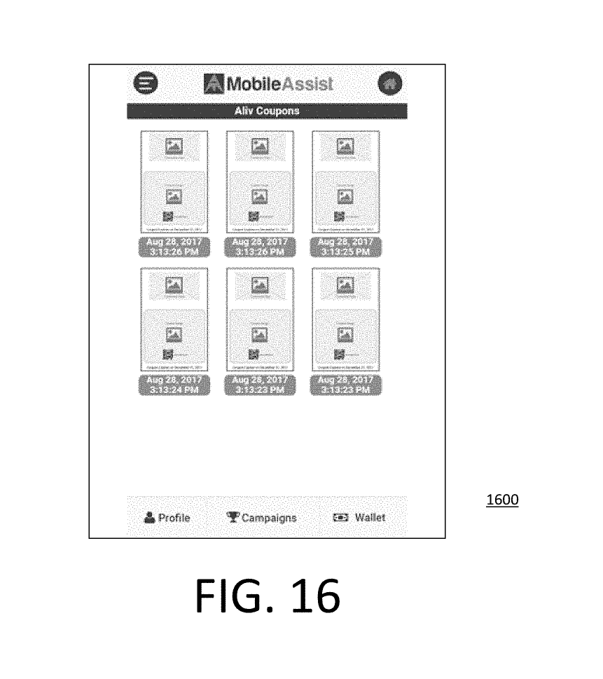

Turning now to FIG. 16, this figure presents a view of the Commercial Customer display consistent with certain embodiments of the present invention. In an exemplary embodiment, upon selection of a Commercial Customer listing by the End User, all available valid coupons will be displayed, with the most recently available valid coupon displaying first, and the End User can select the coupon they wish to use at 1600.

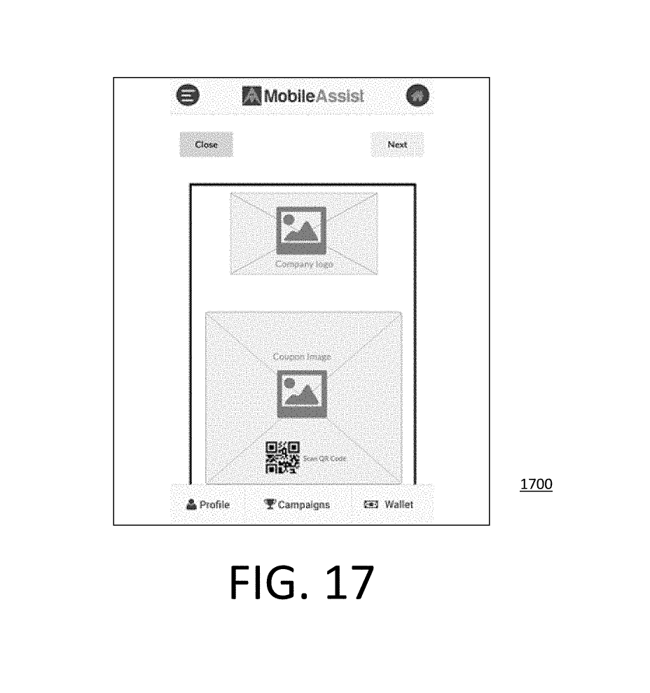

Turning now to FIG. 17, this figure presents a view of one or more coupons selected by an End User consistent with certain embodiments of the present invention. In an exemplary embodiment, the coupon presented by the Commercial Customer may be displayed in full size and can be inspected for use, or the Bar Code or QR Code can be read by a Point of Sales (POS) system at 1700.

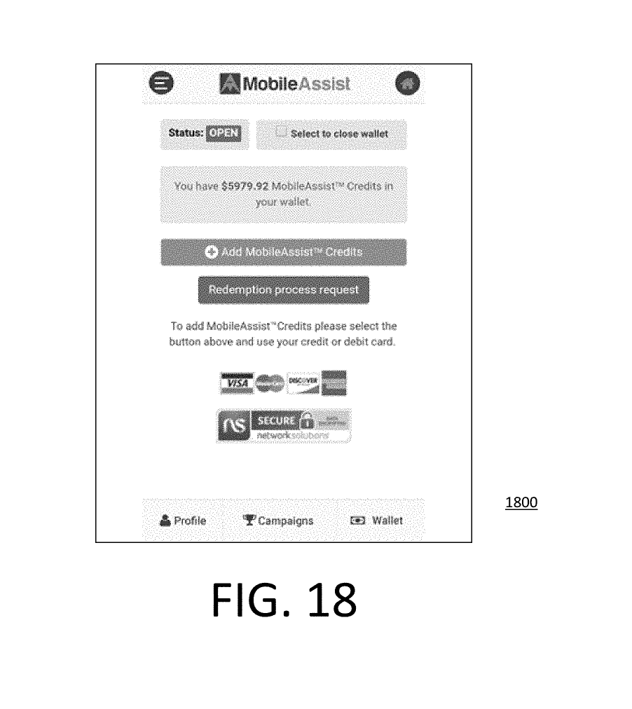

Turning now to FIG. 18, this figure presents a view of the My Wallet function display consistent with certain embodiments of the present invention. In an exemplary embodiment, the My Wallet function allows the End User to view their Mobile Credits balance, as well as add Credits to their Mobile Wallet using their debit or credit card by selecting the Add More Credits button at 1800.

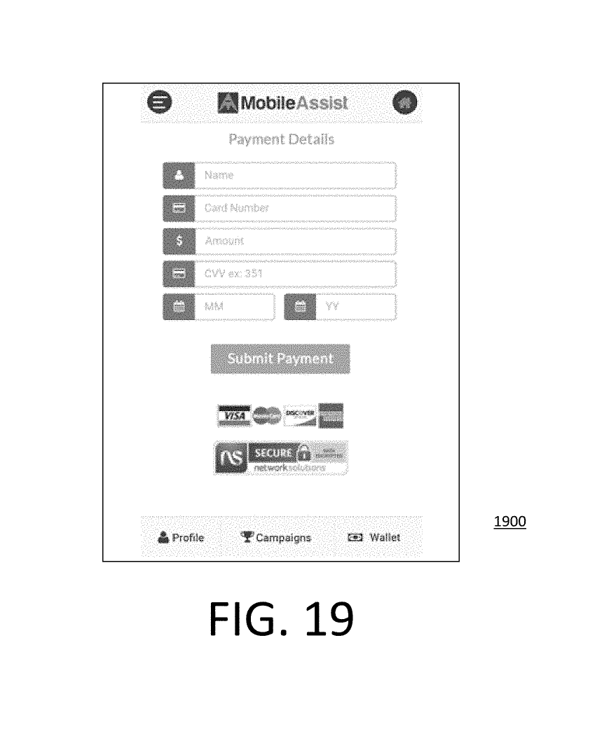

Turning now to FIG. 19, this figure presents a view of End User credit and/or debit card information consistent with certain embodiments of the present invention. In an exemplary embodiment, the End User may utilize this screen to enter their credit and/or debit card and account information, and this account information will be encrypted and saved to their account at 1900.

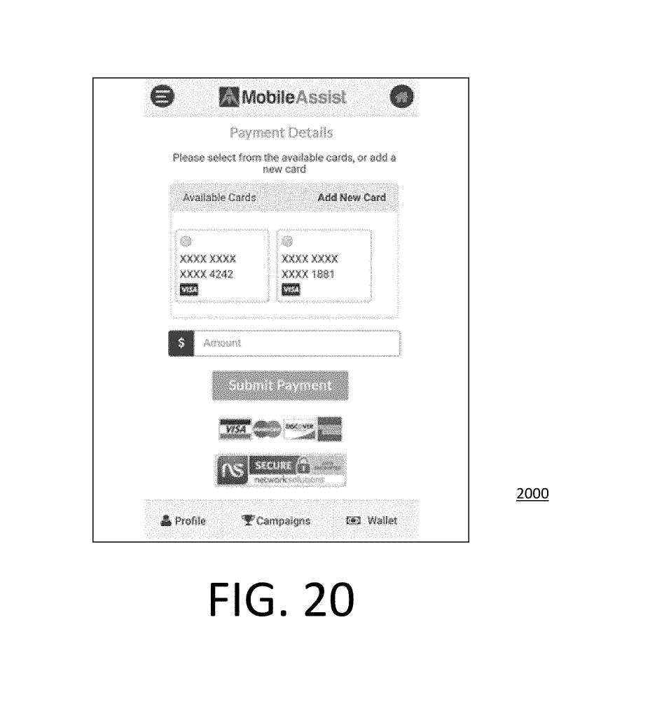

Turning now to FIG. 20, this figure presents a view of the End User credit or debit card to be used consistent with certain embodiments of the present invention. In an exemplary embodiment, the End User selects the card they want to use, enters the amount of Credits to be purchased, and then selects the Submit Payment button at 2000.

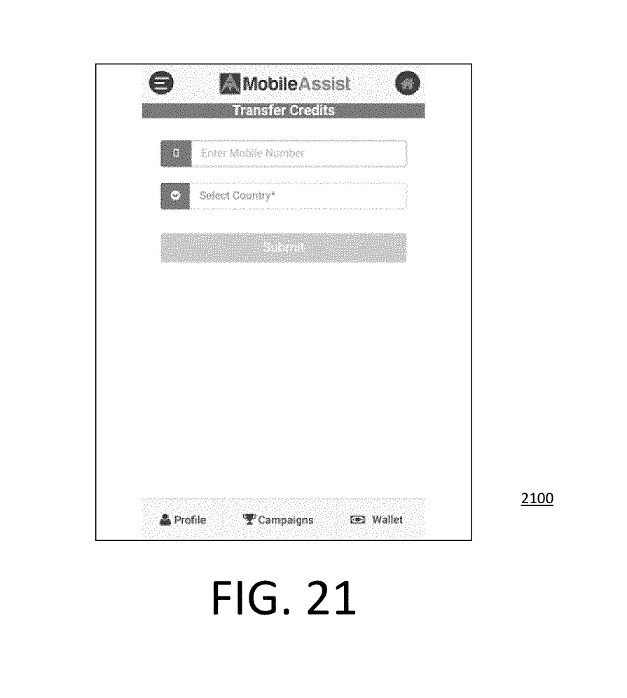

Turning now to FIG. 21, this figure presents a view of the My Credits Transfer main display consistent with certain embodiments of the present invention. In an exemplary embodiment, the My Credits Transfer function allows the Sender End User to enter the phone number and country of the Recipient End User to whom the Credits will be transferred at 2100.

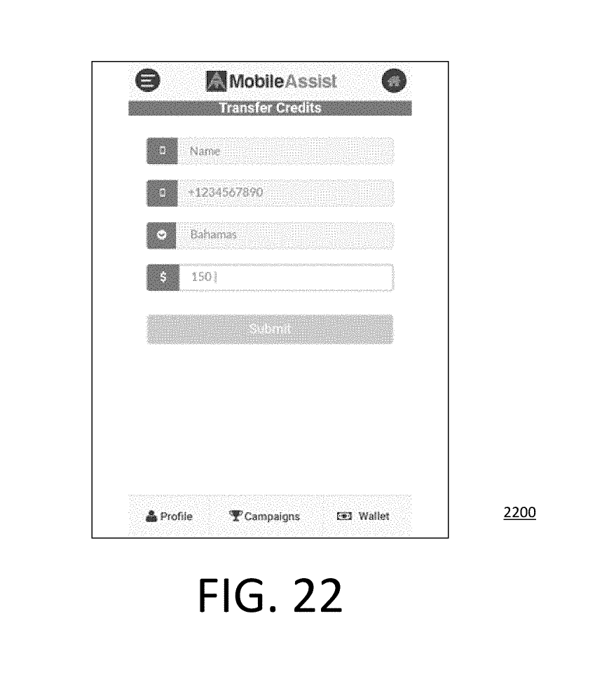

Turning now to FIG. 22, this figure presents a view of verification of entered information for the My Credits Transfer function consistent with certain embodiments of the present invention. In an exemplary embodiment, the phone number and country of the Recipient End User will be verified by the platform, and the system will return the Recipient End User's account information. The Sender End User may then enter the amount to be transferred to the Recipient End User at 2200.

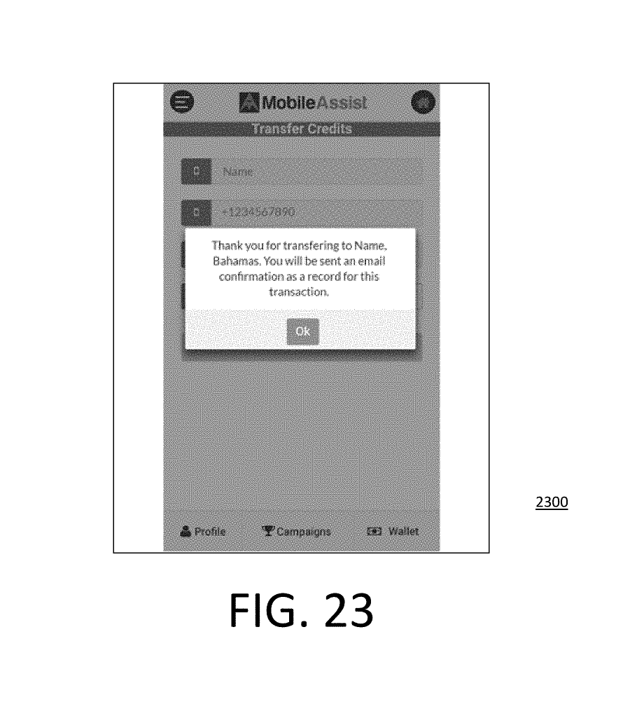

Turning now to FIG. 23, this figure presents a view of the transfer verification screen for the My Credits Transfer function consistent with certain embodiments of the present invention. In an exemplary embodiment, the system will confirm the amount of Credits to be transferred, and will allow the Sender End User to confirm the transaction by selecting the “OK” button. A record of the Credits Transfer will also be listed under the “My Transactions” menu at 2300.

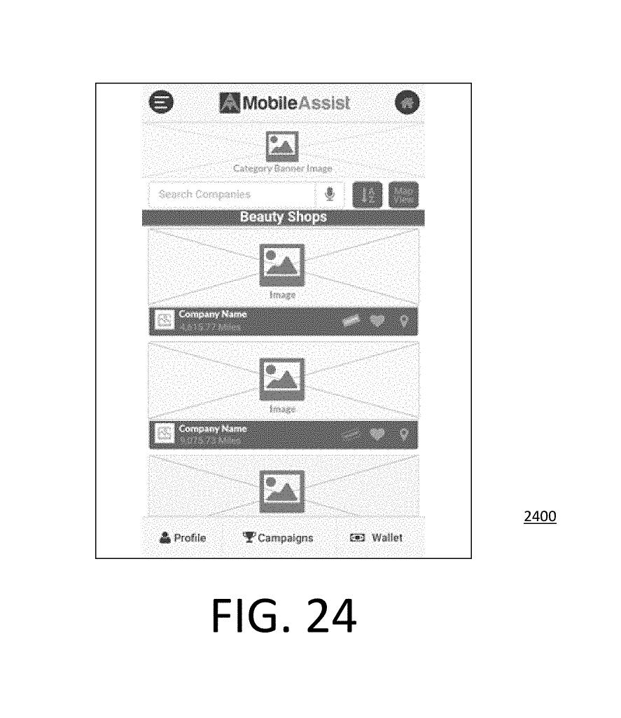

Turning now to FIG. 24, this figure presents a view of a Commercial Customer listing consistent with certain embodiments of the present invention. In an exemplary embodiment, the platform application will create a list of all Commercial Customers registered with the platform application and placing them in pre-defined categories based on channels of commerce. Each category listing is structured as a banner advertisement at the top that is presented to the End User based on their GPS location. Located beneath the banner advertisement may be a search field that allows search of Commercial Customers within the category, followed by a listing of all Commercial Customers in the category based on their proximity to the End User's current location at 2400.

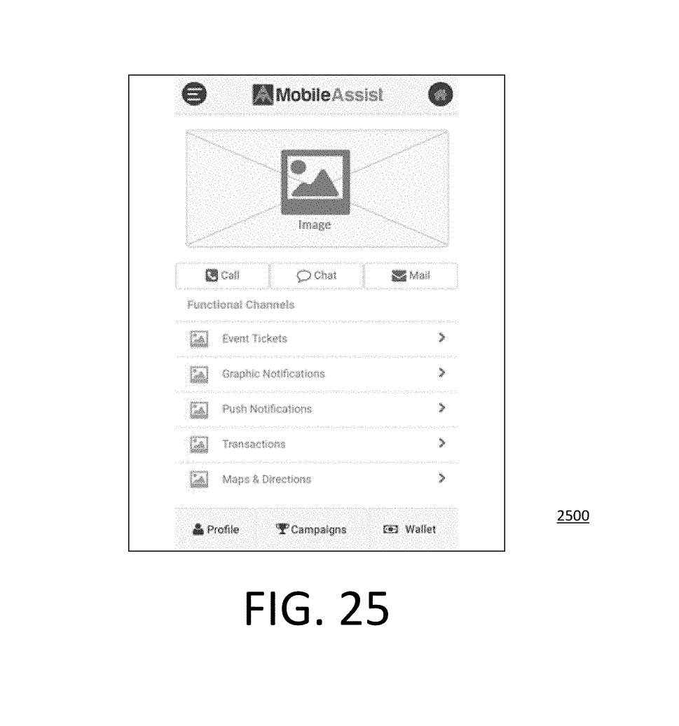

Turning now to FIG. 25, this figure presents a view of an AppPage created for Commercial Customers consistent with certain embodiments of the present invention. In an exemplary embodiment, the AppPage 2500 may be structured to allow for flexibility and extensibility with respect to adding or modifying new functional, communication, and private channels. In this exemplary embodiment, the company logo may be placed at the top, and can be changed via the administrative console. A Call button presents multiple numbers to call, and the phone will automatically call a number selected by the End User. The Email button presents multiple addresses to choose from, and when selected, the phone will allow the End User to select the email client to use to send the email message. The Functional Channels screen portion provides a listing of the functions that have been assigned to the AppPage. In this embodiment, Private Channels may be placed beneath the Functional Channels, which may provide functionality to a select number of End Users, and Communication Channels which may provide links to external social media and internet sites.

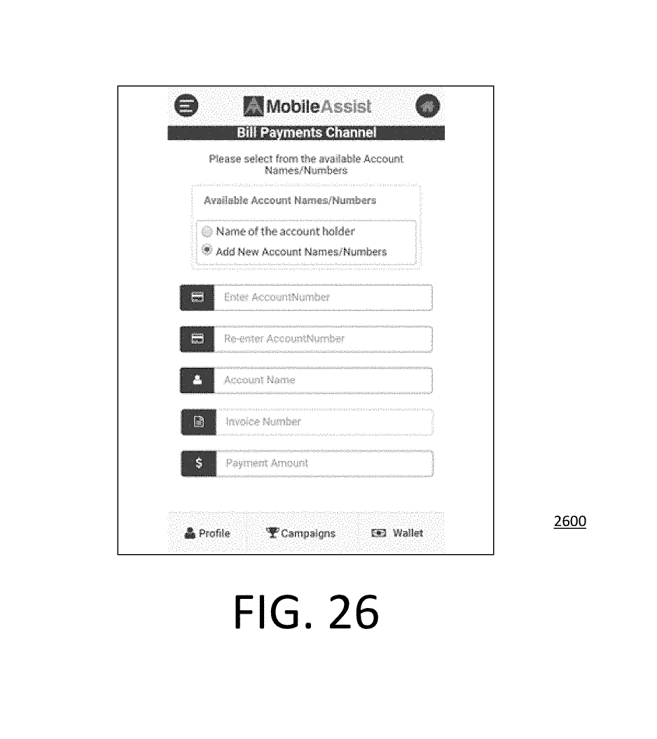

Turning now to FIG. 26, this figure presents a view of the Bill Payment main function screen consistent with certain embodiments of the present invention. In an exemplary embodiment, the Bill Payment function provides an End User with the ability to select a bill for payment and process the transaction through the platform application Bill Payment function at 2600.

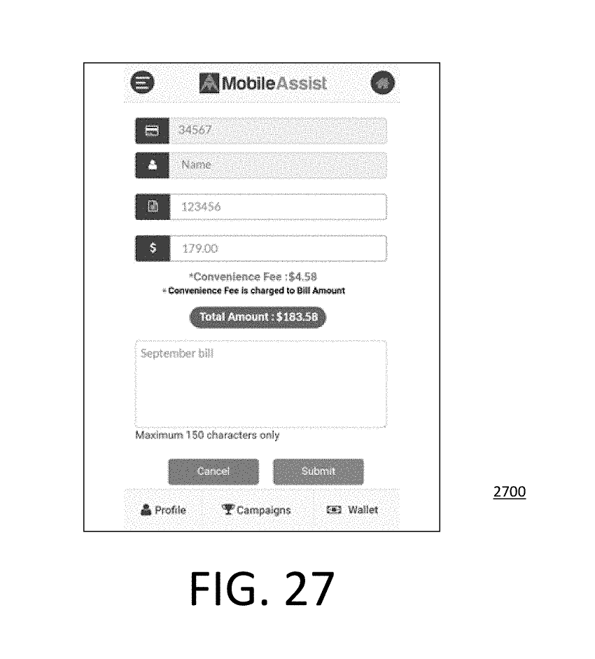

Turning now to FIG. 27, this figure presents a view of the Bill Payment transaction display consistent with certain embodiments of the present invention. In an exemplary embodiment, a user may process a bill payment in three process steps. The End User may first select or create an account with the Commercial Company AppPage for the bill to be paid. The End User may enter the amount of money to be paid, the invoice number, and optional notes or instructions for the processing of this payment. The End User may select the submit button to complete the transaction after reviewing the transaction and any optional notes or instructions for completeness at 2700.

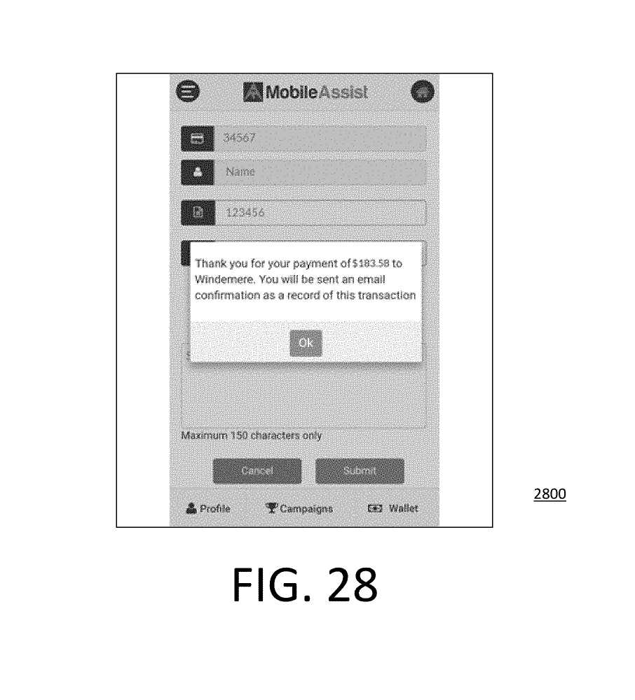

Turning now to FIG. 28, this figure presents a view of a transaction confirmation display for the Bill Payment function consistent with certain embodiments of the present invention. In an exemplary embodiment, upon completion of the payment transaction the End User and Commercial Customer administrator may receive an email confirming the transaction sent by the Bill Payment function at 2800. The details of the transaction will be available to the Commercial Customer through a secure Applications Programmer Interface (API).

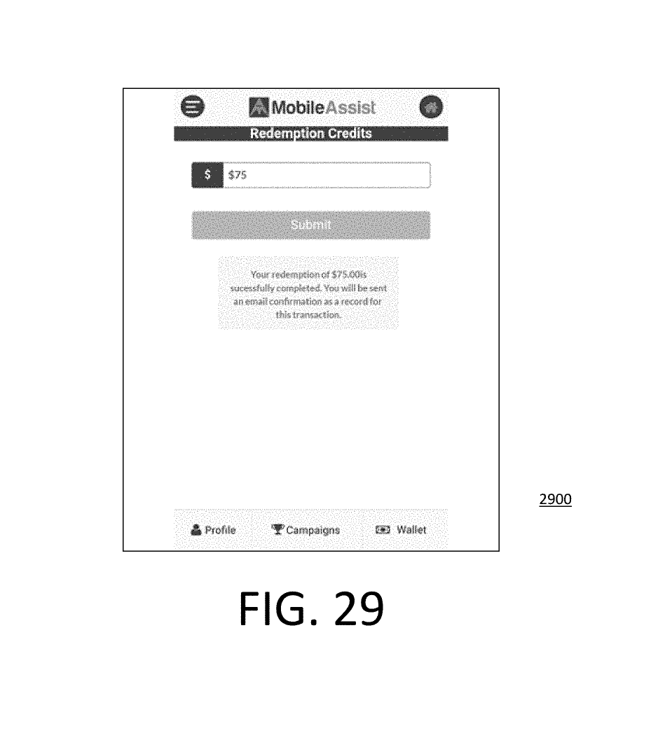

Turning now to FIG. 29, this figure presents a view of a redemption of Credits for cash function consistent with certain embodiments of the present invention. In an exemplary embodiment, the platform application permits an End User to redeem Credits stored within the End User's account with the platform application for cash 2900. To perform this process, the End User first opens the Mobile Wallet associated with their account and enters the amount of Credits they wish to redeem for cash. The End User then selects the submit button. The platform application confirms the redemption request with an in-app notification. The platform application transmits an 8-digit alpha-numeric aOTP to the End User's mobile phone number associated with their in-app profile utilizing SMS messaging.

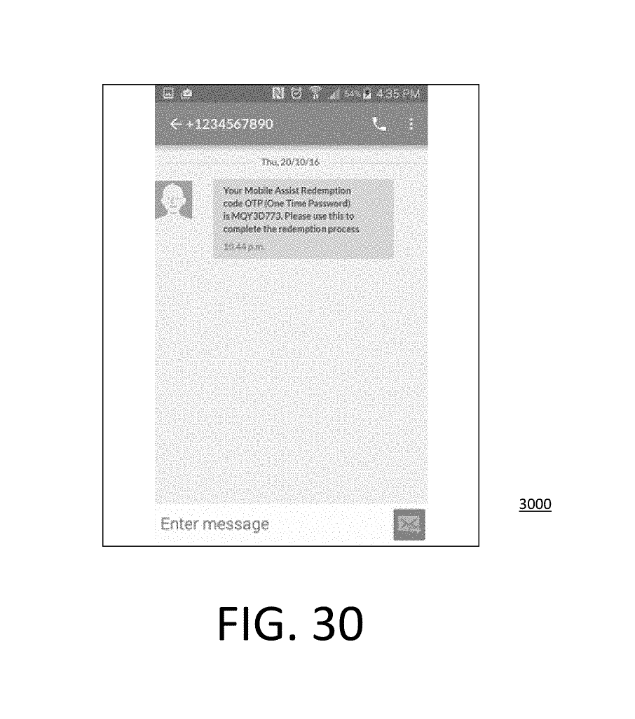

Turning now to FIG. 30, this figure presents a view of the OTP display to complete a transaction consistent with certain embodiments of the present invention. In this embodiment, the End User transmits the aOTP to a designated Credits Redemption location to complete the transaction of redeeming Credits for cash 3000. At the redemption location, a TURC enters the 8-digit authorization aOTP in the platform and the system locks all other TURCs out of using the same passcode for a transaction. The TURC is presented with the name of the End User and verifies the End User's identity, as well as the amount of Credits to be redeemed for cash. The platform application sends the End User a second 8-digit vOTP via SMS messaging, and the End User must provide this second vOTP to the TURC to verify and complete the transaction. If the second vOTP is valid, the TURC provides the End User with cash, less any applicable transaction fees.

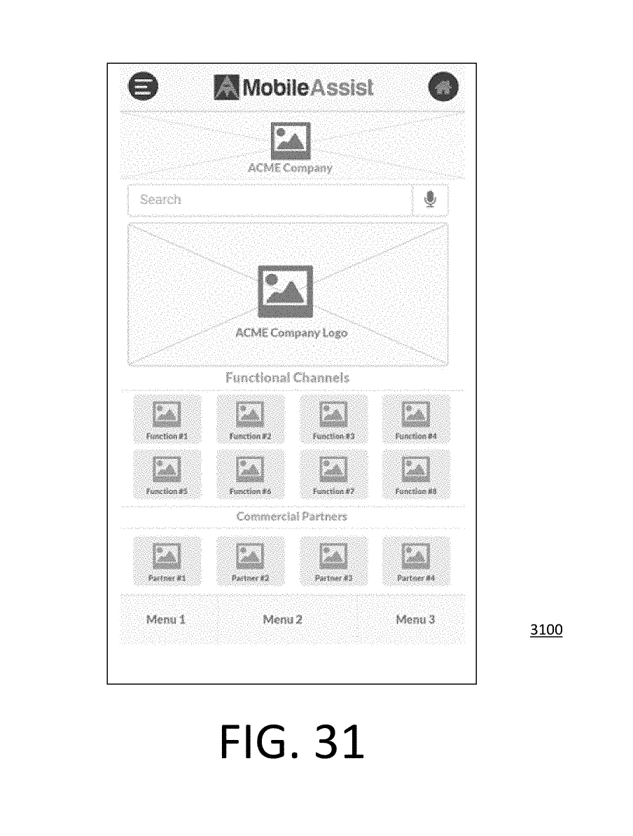

Turning now to FIG. 31, this figure shows a view of the user interface configured for a “White Labeled Application,” and consistent with certain embodiments of the present invention. In a non-limiting example, the White Label Application is part of the platform ecosystem, and may include a number of key design elements, including a Header Section, a Banner Section, a Search Field (which allows for voice or text search within the application), a Center User Interface, and a Footer Menu Section. In an embodiment, such White Label Applications could have a customized look and feel but run on top of the MobileAssist™ platform and database, as exemplified at 3100.

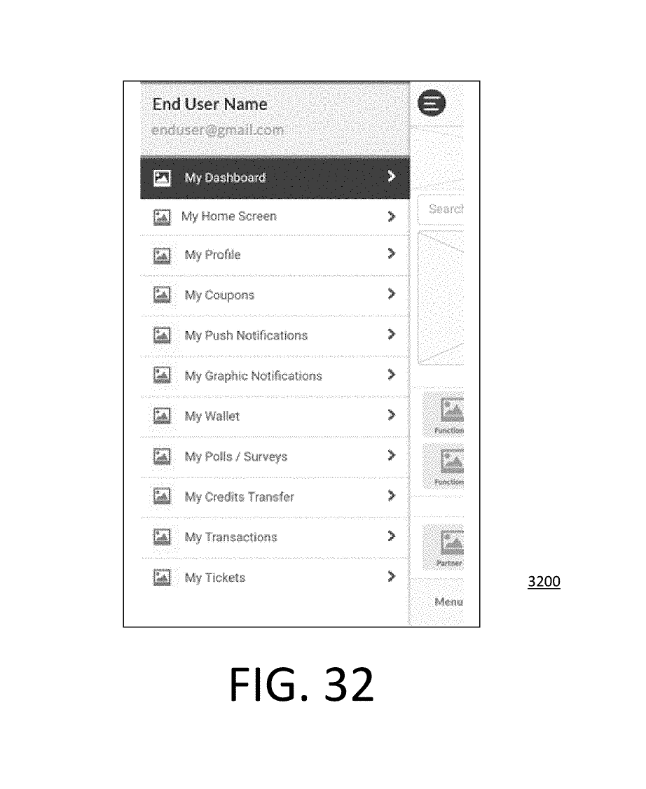

Turning now to FIG. 32, this figure shows a view of the platform application user interface main menu display configured for a “White Label Application,” and consistent with certain embodiments of the present invention. At 3200, the White Label Application (WLA) offers the same functionality available in MobileAssist™, as the WLA is built upon the MobileAssist™ platform.

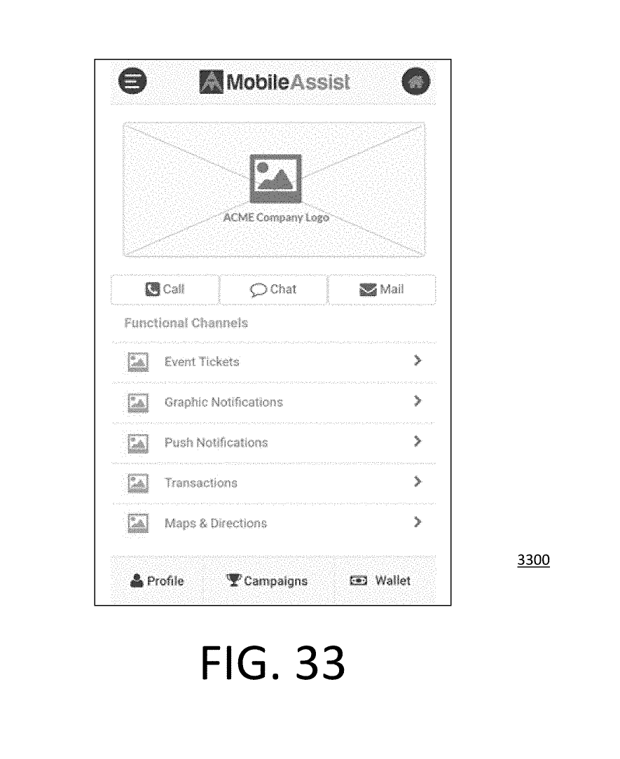

Turning now to FIG. 33, this figure shows a view of an AppPage created for Commercial Customers and configured for “White Label Application,” and consistent with certain embodiments of the present invention. The AppPage can be modified as per market requirements based upon the template at 3300.

While certain illustrative embodiments have been described, it is evident that many alternatives, modifications, permutations, and variations will become apparent to those skilled in the art in light of the foregoing description.

We claim:

1. A system for a mobile application platform architecture, comprising:
a processor having one or more network communication channels;
the network communication channels providing communication between the mobile application platform and a plurality of mobile devices, where each mobile device may be associated with one or more users;
instantiating a software client installed within the system to manage said mobile application platform actions;
the software client performing a user identification approval process, where a user becomes an approved user upon successful identification approval;
the software client providing installation and management actions for a plurality of commercial entity presences on the mobile application platform;
the software client providing an approved user interaction function presenting dynamically updated access to commercial entities registered with the mobile application platform; and
the mobile application platform operative to dynamically manage all interactions between commercial entities registered with the mobile application platform and approved users of the mobile application platform.

2. The system of claim 1 further comprising the software client providing a credits transfer process between approved users.

3. The system of claim 1 further comprising the software client providing monetary redemption and transfer actions between approved users.

4. The system of claim 1, where the user identification approval process requires the submission of a valid government issued identification document to the mobile application platform.

5. The system of claim 4, where the user identification approval process requires an in-person inspection by a human administrator of the system and the user identification approval expires on the government issued identification document expiration date.

6. The system of claim 2, where the credits transfer process may exchange credits between one or more approved users through a transfer of mobile application platform credits from a first approved user to a different approved user.

7. The system of claim 3, where monetary redemption and transfer actions between approved users further comprises redeeming credits for cash, transferring cash from one approved user to a second approved user, or exchanging cash for mobile application platform credits.

8. The system of claim 1, where the registration of commercial entities in the mobile application platform permits one or more commercial entities to place commercial offerings in a reserved space within the mobile application platform for display to approved users and permits each approved user to interact with the commercial offerings to purchase goods and services.

9. The system of claim 1, where the registration of a commercial entity permits the commercial entity to provide one or more multimedia content files to the mobile application platform for presentation to approved users.

10. The system of claim 1, where the mobile application platform confirms transactions involving approved users and commercial entities by utilizing a verification one time passcode provided by the mobile application platform to the approved user, requires the approved user to reenter the verification one time passcode into an input screen, and, upon determining the correct verification one time passcode has been entered by the approved user, performing a requested transaction and provides an acknowledgement of the completed transaction to the approved user.

11. A method for hosting multiple mobile applications via a platform architecture, comprising:
providing processor-driven communication channels between a mobile application platform and a plurality of mobile devices, where each mobile device may be associated with one or more users;
performing a user identification approval process via a software module, where a user becomes an approved user upon successful identification approval;
providing installation and management actions via a software module for a plurality of commercial entity presences on the mobile application platform;
providing, via a software module, an approved user interaction function presenting dynamically updated access to commercial entities registered with the mobile application platform; and
dynamically managing all interactions between commercial entities registered with the mobile application platform and approved users of the mobile application platform on the mobile application platform.

12. The method of claim 11 further comprising a software module operative to provide a credits transfer process between approved users.

13. The method of claim 11 further comprising a software module operative to provide monetary redemption and transfer actions between approved users.

14. The method of claim 11, where the user identification approval process requires the submission of a valid government issued identification document to the mobile application platform.

15. The method of claim 14, where the user identification approval process requires the in person inspection by a human administrator of the system and the user identification approval expires on the government issued identification document expiration date.

16. The method of claim 12, where the credits transfer process may exchange credits between one or more approved users through a transfer of mobile application platform credits from a first approved user to a different approved user.

17. The method of claim 13, where monetary redemption and transfer actions between approved users further comprises redeeming credits for cash, transferring cash from one approved user to a second approved user, or exchanging cash for mobile application platform credits.

18. The method of claim 11, where the registration of commercial entities in the mobile application platform permits one or more commercial entities to place commercial offerings in a reserved space within the mobile application platform for display to approved users and permits each approved user to interact with the commercial offerings to purchase goods and services.

19. The method of claim 11, where the registration of a commercial entity permits the commercial entity to provide one or more multimedia content files to the mobile application platform for presentation to approved users.

20. The method of claim 11, where the mobile application platform confirms transactions involving approved users and commercial entities by utilizing a verification one time passcode provided by the mobile application platform to the approved user, requires the approved user to reenter the verification one time passcode into an input screen, and, upon determining the correct verification one time passcode has been entered by the approved user, performing a requested transaction and provides an acknowledgement of the completed transaction to the approved user.
